(19) United States
(12) Patent Application Publication
(10) Pub. No.: US 2002/0113990 A1
(43) Pub. Date: Aug. 22, 2002

(54) System for providing prioritized data to a printer and paper handling device

(76) Inventor: Tadei Hernandez, Guadalajara (MX)

Correspondence Address: HEWLETT-PACKARD COMPANY, Intellectual Property Administration, P.O. Box 272400, Fort Collins, CO, 80527-2400, US

(21) Appl. No.: 09/789,330

(22) Filed: Feb. 20, 2001

(51) Int. Cl. G06F 15/00; B41J 1/00

(52) U.S. Cl. 358/1.15

(57) ABSTRACT

An apparatus for providing prioritized data to a printer and PHD includes a print preview application on a host computer for displaying a print job and the total number of pages in the print job. A scan application on the host computer obtains the total number of pages of the print job from the print preview. A printer driver connected to the host computer, to the print preview application, and the scan application, transforms the print job into printer acceptable format, the format starting with the total number of pages of the print job. A printer is connected to the printer driver and a PHD is connected to the printer and the printer driver so that together the printer and PHD receive the print job from the printer driver starting with the total number of pages of the print job.

### FIELD OF THE INVENTION

This invention relates to a system for providing prioritized data to a printer and a paper handling device (PHD). In particular, this invention relates to a system and apparatus for providing an appropriately formatted print job to a printer and a PHD starting with the total number of pages of the print job.

### BACKGROUND OF THE INVENTION

It is currently not possible to obtain the number of pages of a print job before it is processed by the printer driver. This information has always been critical for paper handling devices that require this information before the formatted pages start coming into the device. For example, the device may need to make a special mechanical set up before the print job is processed by the printer.

Currently, software applications provide a “print preview” feature in order for the user to “see” what a document will look like before it is printed. In order to accomplish this, a user creates print job information and the print preview application creates this “preview” of the document. When the user is satisfied with the print job, the document is “printed”, and the printer driver receives the information from the software application and then starts to create a printable view of the document again in proper printer format. This system/model, and all others of which the inventor is aware, does not provide a way to communicate the print job size in number of pages as a priority. Currently, the printer driver formats the print job and sends the properly formatted information to the printer and PHD with no information sent in advance concerning the total number of pages of the print job.

A possible solution to this problem is to have the printer driver process the application data and hold it in a print spool until it is finished processing the print job. At this point, the printer driver would “know” the total number of pages of the print job and could send it to the printer and the PHD. Because this solution adds a huge delay in print job processing it is not a viable solution and is not used for this reason.

Accordingly, the present invention is directed to an apparatus and method for providing prioritized print job information to a printer and a PHD. It, therefore, is an object of this invention to provide an improved apparatus and method for providing prioritized data to a printer and PHD so that the total number of pages of the print job is received by the printer and PHD first.

### SHORT STATEMENT OF THE INVENTION

In one embodiment of the invention, a system for providing prioritized data to a printer and PHD includes a host computer and a printer, the host computer for controlling the printer and containing operation applications. A print preview application on the host computer displays a print job and the total number of pages in the print job. A scan application on the host computer obtains the total number of pages of the print job from the print preview. A printer driver is connected to the host computer and to the print preview application and the scan application for transforming the print job into printer acceptable format, the format starting with the total number of pages of the print job. The printer is connected to the printer driver and the PHD is connected to the printer and the printer driver so that the printer and the PHD receive the print job from the printer driver starting with the total number of pages of the print job.

In a preferred embodiment, the apparatus includes multiple host computers, printer drivers, printers and PHDs connected in an intranet. In a further preferred embodiment, multiple host computers, printer drivers, printers and PHDs are connected on the Internet. In one preferred embodiment the printer driver is located on the host computer and, in another preferred embodiment, the printer driver is located on the printer.

In yet another preferred embodiment, the PHD receives the total number of pages for use in the selection of suitable mechanical settings, such as, and including, paper tray selection.

In a preferred embodiment, a method for providing prioritized data to a printer and PHD is disclosed including the steps of installing a print preview application on a host computer and displaying a print job and the total number of pages of the print job. A scan application is also installed on the host computer and obtains the total number of pages of the print job from the print preview application. A printer driver is connected to the host computer, the print preview application, and the scan application as well. The printer driver transforms the print job into printer acceptable format starting with the total number of pages of the print job. Finally, a printer is connected to the printer driver and the PHD is connected to the printer and printer driver such that the printer and PHD receive the print job format from the printer driver starting with the total number of pages of the print job.

In another preferred embodiment, computer code for providing prioritized data to a printer and PHD on computer readable medium includes computer code loaded on a host computer for displaying a preview of a print job and the total number of pages of the print job. Computer code loaded on the host computer scans the print job preview and obtains the total number of pages of the print job. Computer code, on the host computer transforms the print job preview into printer usable format starting with the total number of pages of the print job. Finally, the printer and PHD are connected to the host computer and receive the formatted print job starting with the total number of pages of the print job.

### BRIEF DESCRIPTION OF THE DRAWINGS

FIG. 1 is a schematic of an apparatus for providing prioritized data to a printer and PHD according to one embodiment of the present invention.

FIG. 2 is a flow diagram of one embodiment of the present invention.

### DETAILED DESCRIPTION OF THE PREFERRED EMBODIMENTS

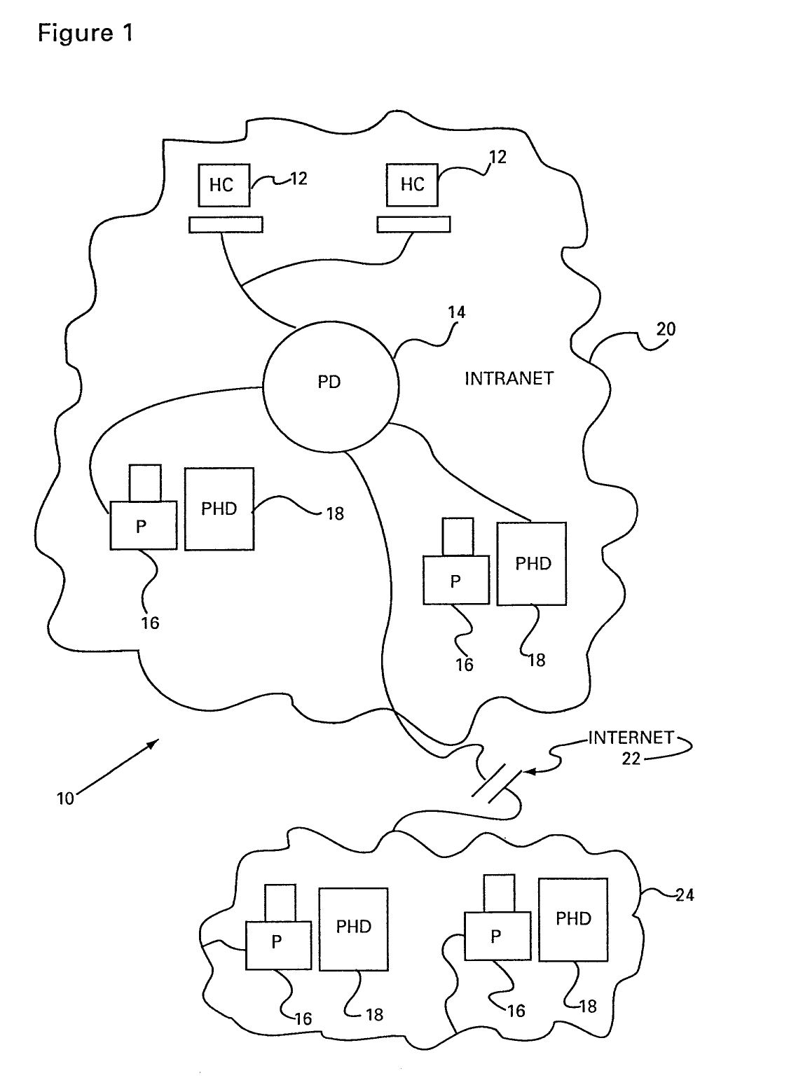

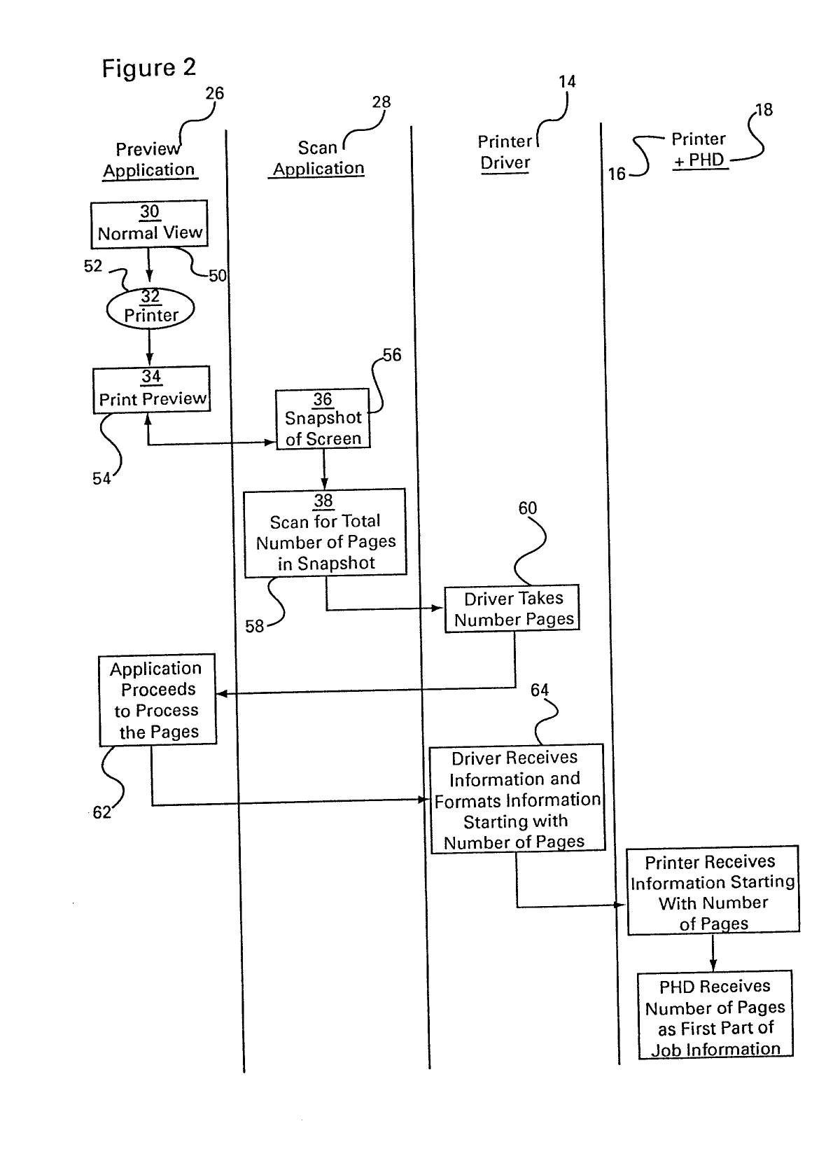

The preferred embodiments of the present invention are illustrated by way of example in FIGS. 1-2. With specific reference to FIG. 1, an apparatus for providing prioritized data to a printer and PHD 10 includes a host computer 12, printer driver 14, printer 16 and PHD 18. As illustrated, invention 10 may include multiple host computers 12 as well as multiple printers 16 and PHDs 18.

Host computer 12 may be any computer system now known or hereafter developed. Host computer 12 controls the printer 16 and contains software operation applications. Specifically, host computer 12 of the present invention includes a print preview application for use in displaying a print job and the total number of pages in that print job. A scan application, according to the present invention, is also installed on host computer 12. The scan application scans the print preview of a print job looking for the total number of pages of the print job. Once located, the scan application provides this information to the printer driver 14. As is known in the art, it is common for print preview applications to create a print preview screen. The print preview screen typically includes information such as “page 1 of 20”, for example. In operation, the scan application of the present invention scans the print preview screen only for the second figure that is commonly displayed, i.e. “20”, representing the total number of pages of the print job.

Printer driver 14 is connected to host computer 12 and thereby to the print preview application and the scan application. The function of printer driver 14 is well known. Any printer driver 14 now known or hereafter developed is suitable so long as it performs the function of transforming the print job into printer 16 acceptable format. Importantly, in accordance with the present invention the transformation of the print job into printer 16 acceptable format requires the formatted information sent to the printer 16 and PHD 18 to start with the total number of pages of the print job. Again, the scan application obtains this information and sends it to the printer driver 14.

At this point, printer 16, connected to printer driver 14 and PHD 18, is in position to receive the formatted information from the printer driver 14 starting with the total number of pages of the print job.

Still referring to FIG. 1, the present invention envisions the connection of printer driver 14 to multiple host computers 12, as well as to multiple printers 16 and PHDs 18. As such, the invention includes the utilization of an intranet 20 to accommodate multiple users. Also, printer driver 14 may be connected through an intranet to local multiple users or through the Internet 22 to remote printers 16 and PHDs 18 in other remote intranets 24.

Referring now to FIG. 2, a flow diagram further illustrates and explains the operation of the apparatus and method 10 for providing prioritized data to printer 16 and PHD 18. The figure illustrates four main divisions of the invention including preview application 26, scan application 28, printer driver 14, and printer 16 and PHD 18 together. It should be understood that printer driver 14, as well as printer 16 and PHD 18, may be controlled and manipulated by host computer 12 by resident software applications for the printer driver 14 printer 16 and PHD 18, for example.

When a print job is commenced, preview application 26 creates a “normal view” 30 in block 50. As is known in the art, a user manipulates the information through host computer 12 until the material is acceptable. At that point, a user presses print 32 in block 52 and preview application 26 creates a print preview 34 in block 54. At that point, scan application 28 takes a snapshot of the screen 36 in block 56 and scans for the total number of pages 38 in the snapshot in block 58.

Scan application 28 then sends the total number of pages 38 obtained in block 58 to printer driver 14 in block 60. This is the first step in the normal process of formatting the information into acceptable printer format. However, in accordance with the present invention, the total number of pages 38, obtained in block 58, of the print job is maintained at the beginning of the information processed in block 62 for the print job. That is to say, scan application 28 requires printer driver 14 to keep the total number of pages 38 of the print job at the head of the information that is being processed. Upon completion, preview application 26 creates another image of the material to be printed in block 62 and sends the processed information to the printer driver 14 in block 64. At this point, printer driver 14 receives the processed information in block 64 and formats the information in a manner acceptable to printer 16, the information formatted in such a way that it begins with the total number of pages 38 of the print job. From there, printer driver 14 sends the information to printer 16 starting with the total number of pages 38 of the print job. PHD 18 connected through printer 16 (as illustrated in FIG. 2), or directly as desired to printer driver 14, receives the total number of pages 38 of a job as the first job information received.

Certain advantages may be obtained by the consolidation of the various elements of the invention 10. That is to say, in a preferred environment, printer driver 14 is located on host computer 12. Likewise, in a preferred environment, printer driver 14 is located on printer 16. Certainly, it may be that a single device includes each major element of the invention i.e. host computer 12, printer driver 14, printer 16 and PHD 18.

Determining the exact size of a print job is useful for many purposes including, but not limited to, the selection of suitable mechanical settings for PHD 18. One particular suitable mechanical setting includes paper tray selection, for example. Likewise, the invention is useful in: determining if the print job can be finished properly (are there limitations in the stapler for example); and for preparing the right amount of a consumable based on the number of pages. For example, the amount of melting glue for binding a book.

The method of providing prioritized data to printer 16 and PHD 18 using a computer system with a host computer 12, includes installing a print preview application 26 on host computer 12. The print preview application 26, again, displays a print job and the total number of pages 38 of the print job. Next, the scan application 28 on host computer 12 scans the print preview 34 and obtains the total number of pages 38 of the print job from the print preview application 26. The printer driver 14, connected to host computer 12, to print preview application 26 and to scan application 28, transforms the print job into printer acceptable format starting with the total number of pages 38 of the job. The connected printer 16 and PHD 18 thereby receive properly formatted information from printer driver 14 starting with the total number of pages 38 of the print job as required by scan application 28.

This method can be understood to have added the step of providing the printer driver 14 with preprocessing and pre-formatting information after a user selects print 32 at block 52. In normal circumstances, once the print preview 34 is reviewed in block 54, preview application 26 proceeds to process the information and images of the print job. According to the present invention however, scan application 28 then inserts itself in the process to obtain the one bit of data for which it searches i.e. the total number of pages 38 of the job. Again, this information is directed to printer driver 14 and maintained in the first position in the information as the information is processed in block 62 prior to passing the processed information to the printer driver 14 in block 64. As a result, the printer driver 14 formats the print information starting with the total number of pages 38 of the print job. Thus, printer 16 and PHD 18 receive prioritized, properly formatted data starting with the total number of pages 38 of the print job.

In another preferred embodiment, the invention is embodied in computer code for providing prioritized data to the printer 16 and PHD 18. Here, the essential elements of the invention 10 are found in computer code recorded on computer readable medium. In particular, the computer code includes computer code for displaying a preview of a print job and the total number of pages of the print job. Computer code utilized by and installed on host computer 12 scans the print job preview and obtains the total number of pages of the print job as previously described. Computer code on host computer 12, transforms the print job preview into printer usable format starting with the total number of pages of the print job. Computer code on the printer 16 is connected to host computer 12. PHD 18 is connected to printer 16 and as a result, both the printer 16 and PHD 18 receive the formatted print job starting with the total number of pages of the print job first. In a preferred embodiment, the computer code is bundled together as a printer driver 14.

While the present invention has been disclosed in connection with the preferred embodiment thereof, it should be understood that there may be other embodiments which fall within the spirit and scope of the invention as defined by the following claims.

We claim:

1. An apparatus for providing prioritized data to a printer and a PHD, including a host computer, the host computer for controlling the printer and containing operation applications, the apparatus comprising:
(a) a print preview application on said host computer for displaying a print job and the total number of pages in the print job;
(b) a scan application on said host computer for obtaining the total number of pages of the print job from said print preview;
(c) a printer driver connected to said host computer, to said print preview application, and to said scan application for transforming the print job into printer acceptable format the format starting with the total number of pages of the print job; and
(d) the printer connected to said printer driver and the PHD connected to said printer and said printer driver so that said printer and PHD receive the print job from the printer driver starting with the total number of pages of the print job.

2. The system of claim 1 further comprising multiple host computers, printer drivers, printers and PHDs connected in an intranet.

3. The system of claim 1 further comprising multiple host computers, printer drivers, printers and PHDs connected on the Internet.

4. The system of claim 1 wherein said printer driver is located on said host computer.

5. The system of claim 1 wherein said printer driver is located on said printer.

6. The system of claim 1 wherein said PHD receives said total number of pages and selects suitable mechanical settings.

7 The system of claim 6 wherein said selection of suitable mechanical settings includes paper tray selection.

8. A method for providing prioritized data to a printer and a PHD in a computer system with a host computer, the host computer for controlling the printer and containing applications, the method comprising the steps of:
(a) previewing on the host computer the total numbers of pages in a print job;
(b) obtaining the total number of pages of the print job from said preview;
(c) transforming the print job into printer acceptable format starting with the total number of pages of the print job; and
(d) sending the print job format to the printer and PHD starting with the total number of pages of the print job.

9. A method for providing prioritized data to a printer and a PHD in a computer system with a host computer, the host computer for controlling the printer and containing applications, the method comprising the steps of:
(a) installing a print preview application on said host computer for displaying a print job and the total numbers of pages in the print job;
(b) installing a scan application on said host computer for obtaining the total number of pages of the print job from said print preview application;
(c) connecting a printer driver to said host computer, to said print preview application, and to said scan application, said printer driver transforming the print job into printer acceptable format, the format starting with the total number of pages of the print job; and
(d) connecting the printer to the printer driver and connecting the PHD to the printer and the printer driver such that said printer and PHD receive the print job format from the printer driver starting with the total number of pages of the print job

10. The method of claim 9 further comprising the step of connecting multiple host computers, printer drivers, printers and PHDs in an intranet.

11. The method of claim 9 further comprising the step of connecting multiple host computers, printer drivers, printers and PHDs in an Internet.

12. The method of claim 9 further comprising the step of installing the printer driver on the host computer.

13. The method of claim 9 further comprising the step of installing the printer driver on the printer.

14. The method of claim 9 further comprising the step of said PHD utilizing the total number of pages to select appropriate mechanical settings.

15. In a computer-printer system, including a host computer and a printer, the host computer for controlling the printer and containing computer code, computer code for providing prioritized data to the printer and a PHD on computer readable medium comprising:
(a) computer code on said host computer for displaying a preview of a print job and the total number of pages of the print job;
(b) computer code on said host computer for scanning the print job preview and obtaining the total number of pages of the print job;
(c) computer code connected to said host computer for transforming the print job preview into printer useable format starting with the total number of pages of the print job; and
(d) computer code on said printer connected to said host computer for receiving the formatted print job starting with the total number of pages of the print job.

16. The invention of claim 15 further comprising computer code for connecting multiple host computers and printers in an intranet.

17. The invention of claim 15 further comprising computer code for connecting multiple host computers and printers in an Internet.

18. The invention of claim 15 further comprising a computer code for using the total number of pages of a print job to make PHD mechanical setting decisions.

19. The invention of claim 18 wherein said mechanical setting decisions include selection of paper trays.

20. The invention of claim 15 wherein said computer code is bundled together as a printer driver.
